(19) United States
(12) Patent Application Publication
(10) Pub. No.: US 2007/0035223 A1
(43) Pub. Date: Feb. 15, 2007

(54) Backlight assembly and display device having the same

(75) Inventors: Byung-Cheon Yoo, Cheongwon-gun (KR); Hea-Chun Lee, Suwon-si (KR); Hyun-Chul Bae, Suwon-si (KR); Jae-Sang Lee, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/346,702

(22) Filed: Feb. 3, 2006

(30) Foreign Application Priority Data
Aug. 10, 2005 (KR) 2005-73093

(51) Int. Cl. H01J 61/52; H01J 1/62

(52) U.S. Cl. 313/27; 313/493

(57) ABSTRACT

A backlight assembly includes a receiving container, a flat fluorescent lamp and a heat generating sheet. The flat fluorescent lamp is received in the receiving container. The flat fluorescent lamp includes a plurality of discharge spaces to generate light. The heat generating sheet is positioned adjacent to the flat fluorescent lamp, for example, under the flat fluorescent lamp, to supply the flat fluorescent lamp with heat. The heat generating sheet corresponds to an effective light emitting region of the flat fluorescent lamp where the light is emitted. As a result, heat is provided to the flat fluorescent lamp, thereby decreasing a time for stabilizing a luminance and improving light emitting characteristics.

CROSS REFERENCE TO RELATED APPLICATION

The present application claims priority to Korean Patent Application No. 2005-73093, filed on Aug. 10, 2005, the disclosure of which is hereby incorporated herein by reference in its entirety.

### BACKGROUND OF THE INVENTION

1. Technical Field

The present disclosure relates to a backlight assembly and, more particularly, to a backlight assembly capable of decreasing a time for stabilizing luminance to improve light emitting characteristics and a display device having the backlight assembly.

2. Discussion of the Related Art

A liquid crystal display (LCD) device, in general, displays an image using liquid crystal that has an optical characteristic such as refractive anisotropy and an electrical characteristic such as dielectric constant anisotropy. The LCD device has various characteristics such as, for example, being thinner, using a lower driving voltage, and using less power than other d isplay devices such as, for example, a cathode ray tube (CRT) device or a plasma display panel (PDP) device. Therefore, the LCD device is used in various applications.

The LCD device can be a non-emissive type display device requiring a backlight assembly to supply an LCD panel of the LCD device with light.

The LCD device may include a cold cathode fluorescent lamp (CCFL) having a thin cylindrical shape that is extended in a predetermined direction. As the LCD device becomes large in size, the number of the CCFLs is increased, which in turn increases a manufacturing cost of the LCD device and deteriorates optical characteristics such as uniformity of luminance.

A flat fluorescent lamp has been developed to generate a planar light. In order to emit light uniformly over a large area, the flat fluorescent lamp includes a lamp body having a plurality of discharge spaces and electrodes through which a discharge voltage is applied to the lamp body.

An inverter applies the discharge voltage to the electrodes to form a plasma discharge in the discharge spaces. An ultraviolet light generated in the discharge spaces is converted into a visible light by a fluorescent layer formed on an inner surface of the lamp body.

When a surface temperature of the flat fluorescent lamp is increased to about 40° C., a luminance of the flat fluorescent lamp is about 90% of a maximum luminance of the flat fluorescent lamp. More heat is generated adjacent to the electrodes than at a central portion of the flat fluorescent lamp so that a time for heating the central portion of the flat fluorescent lamp is increased. Therefore, the flat fluorescent lamp has a longer heating time than the CCFL. As a result, the time for stabilizing the flat fluorescent lamp is longer than that of the CCFL.

### SUMMARY OF THE INVENTION

Embodiments of the present invention provide a backlight assembly capable of decreasing a time for stabilizing a luminance to improve light emitting characteristics, and a display device having the above-mentioned backlight assembly.

A backlight assembly in accordance with an embodiment of the present invention includes a receiving container, a flat fluorescent lamp and a heat generating sheet. The flat fluorescent lamp is received in the receiving container. The flat fluorescent lamp includes a plurality of discharge spaces to generate light. The heat generating sheet is positioned adjacent to the flat fluorescent lamp, for example, under the flat fluorescent lamp to supply the flat fluorescent lamp with heat.

The heat generating sheet may be on an effective light emitting region of the flat fluorescent lamp. The light emits from the effective light emitting region.

The heat generating sheet may include a heat generating plate, electrode portions on end portions of the heat generating plate, and a power supply line electrically connected to the electrode portions to apply electric power to the electrode portions.

The heat generating sheet may also include a heating line having a metal wire, an insulating layer on the heating line, and a power supply line through which electric power is applied to the heating line.

A liquid crystal display device in accordance with an embodiment of the present invention includes a backlight assembly and a display unit. The backlight assembly generates light, and includes a receiving container, a flat fluorescent lamp and a heat generating sheet. The flat fluorescent lamp is received in the receiving container, and includes a plurality of discharge spaces to generate the light. The heat generating sheet is positioned adjacent to the flat fluorescent lamp, for example, under the flat fluorescent lamp to supply the flat fluorescent lamp with heat. The display unit includes a liquid crystal display panel that displays an image using the light generated from the backlight assembly, and a driving circuit part that generates control signals to drive the liquid crystal display panel.

According to embodiments of the present invention, the heat generating sheet is under the flat fluorescent lamp to supply the effective light emitting region of the flat fluorescent lamp with heat. Therefore, a time for stabilizing the flat fluorescent lamp is decreased, and light emitting characteristics of the flat fluorescent lamp are improved.

### BRIEF DESCRIPTION OF THE DRAWINGS

Preferred embodiments of the present invention can be understood in more detail from the following descriptions taken in conjunction with the accompanying drawings, in which:

FIG. 1 is an exploded perspective view showing a backlight assembly in accordance with an embodiment of the present invention;

FIG. 2 is a cross-sectional view of the backlight assembly shown in FIG. 1;

FIG. 3 is a plan view of a heat generating sheet shown in FIG. 1 in accordance with an embodiment of the present invention;

FIG. 4 is a cross-sectional view taken along a line I-I′ shown in FIG. 3;

FIG. 5 is a plan view showing a heat generating sheet in accordance with an embodiment of the present invention;

FIG. 6 is a perspective view of a flat fluorescent lamp shown in FIG. 1 in accordance with an embodiment of the present invention;

FIG. 7 is a cross-sectional view taken along a line II-II′ shown in FIG. 6;

FIG. 8 is a cross-sectional view taken along a line III-III′ shown in FIG. 6; and

FIG. 9 is an exploded perspective view showing a liquid crystal display (LCD) device in accordance with an embodiment of the present invention.

### DETAILED DESCRIPTION OF THE EXEMPLARY EMBODIMENTS

Exemplary embodiments of the present invention will now be described more fully hereinafter in more detail with reference to the accompanying drawings, in which exemplary embodiments of the invention are shown. This invention may, however, be embodied in many different forms and should not be construed as limited to the embodiments set forth herein.

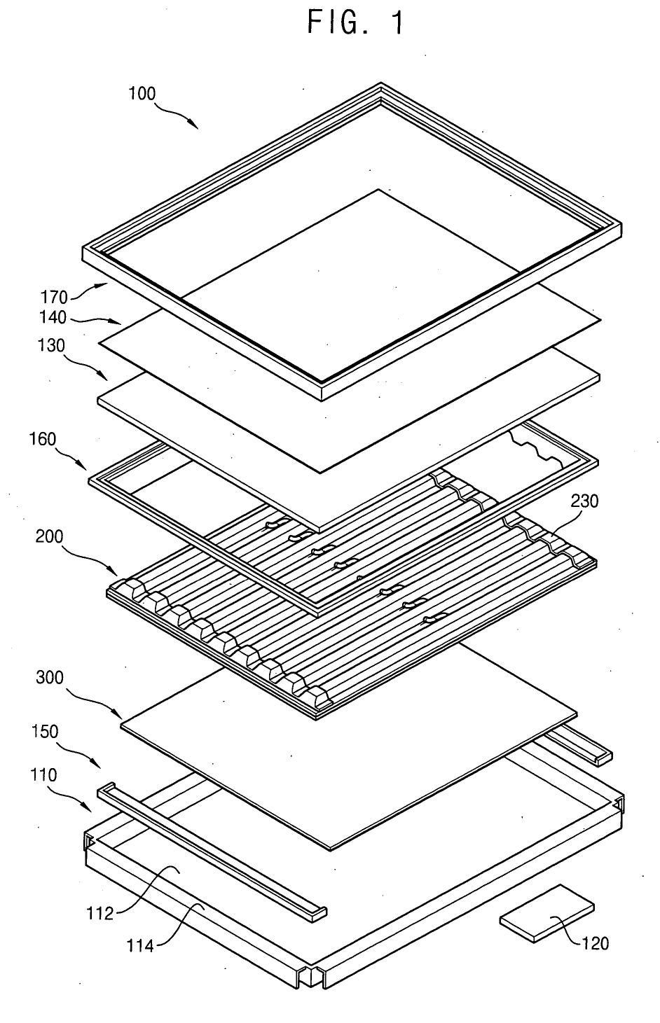

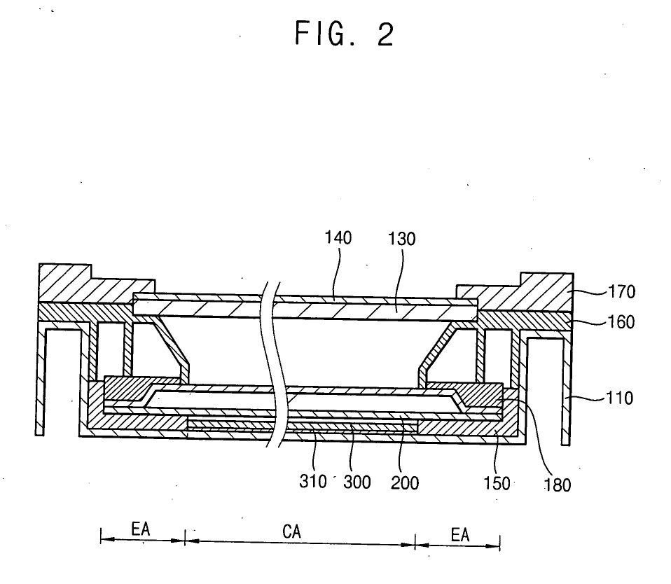

FIG. 1 is an exploded perspective view showing a backlight assembly in accordance with an embodiment of the present invention. FIG. 2 is a cross-sectional view of the backlight assembly shown in FIG. 1.

Referring to FIGS. 1 and 2, the backlight assembly 100 includes a receiving container 110, a flat fluorescent lamp 200 and a heat generating sheet 300.

The receiving container 110 includes a bottom portion 112 and a side portion 114 to receive the flat fluorescent lamp 200. The side portion 114 protrudes from sides of the bottom portion 112. A portion of the side portion 114 is bended to form an U shape so that the side portion 114 can be securely combined with other elements such as, for example, a chassis and a mold frame. The U shaped side portion 114 forms a receiving space for such elements. The receiving container 110 hincludes metal that is strong enough to avoid being deformed.

The flat fluorescent lamp 200 is received in the receiving container 110. The flat fluorescent lamp 200 includes a plurality of discharge spaces that are spaced apart from each other to generate light. The flat fluorescent lamp 200 has a substantially quadrangular shape to generate planar light.

The flat fluorescent lamp 200 generates a plasma discharge in the discharge spaces based on an electric power from a power supplying part 120. An ultraviolet light is generated based on the plasma discharge. The ultraviolet light is converted into visible light. The flat fluorescent lamp 200 includes discharge spaces that are spaced apart from each other to increase a size of a light emitting surface so as to increase luminance uniformity.

A heat generating sheet 300 is positioned adjacent to the flat fluorescent lamp 200, for example, under or to the rear of the flat fluorescent lamp 200. The heat generating sheet 300 generates heat based on the electric power from the power supplying part 120 to supply the flat fluorescent lamp 200 with heat.

The heat generating sheet 300 corresponds to an effective light emitting area CA of the flat fluorescent lamp 200. The flat fluorescent lamp 200 further includes an electrode region EA on which an external electrode 230 is formed to receive the electric power. The electrode region EA is on opposite end portions of the flat fluorescent lamp 200. The light is not generated in the electrode region EA. A large amount of heat is generated in the electrode region EA. Therefore, the light is generated in a region corresponding to the heat generating sheet 300, and the heat generating sheet 300 corresponds to the effective light emitting region CA, which has lower temperature than the electrode region EA.

When the heat is generated from the heat generating sheet 300 in the effective light emitting region CA of the flat fluorescent lamp 200, a time for stabilizing a luminance of the flat fluorescent lamp 200 is decreased. In FIGS. 1 and 2, the time for stabilizing the luminance of the flat fluorescent lamp 200 is substantially equal to a time for increasing a surface temperature of the flat fluorescent lamp 200 to about 40° C. When the surface temperature of the flat fluorescent lamp 200 is about 40° C., the luminance of the flat fluorescent lamp 200 is about 90% of a maximum luminance of the flat fluorescent lamp 200.

The heat generating sheet 300 may be attached to a bottom surface of the receiving container 110 through an adhesive member 310. Examples of the adhesive member 310 that can be used to attach the heat generating sheet 300 to the receiving container 110 include double sided tape, glues or other adhesives. Alternatively, the heat generating sheet 300 may be combined with the receiving container 110 using a fastening device(s), such as a screw.

The backlight assembly 100 may further include the power supplying part 120 that applies the electric power to the flat fluorescent lamp 200 and the heat generating sheet 300.

The power supplying part 120 is located on a rear surface of the receiving container 110. The power supplying part 120 elevates a level of an externally provided: voltage to apply an alternating current electric power to the flat fluorescent lamp 200. In addition, the power supplying part 120 applies a direct current electric power to the heat generating sheet 300.

The power supplying part 120 may be one printed circuit board. Alternatively, the power supplying part 120 may include a printed circuit board for applying the electric power to the flat fluorescent lamp 200 and a printed circuit board for applying the electric power to the heat generating sheet 300.

The backlight assembly 100 may include a diffusion plate 130 and optical sheets 140. The diffusion plate 130 is positioned on the flat fluorescent lamp 200. The optical sheets 140 are positioned on the diffusion plate 130.

The diffusion plate 130 diffuses the light generated from the flat fluorescent lamp 200 to increase the luminance uniformity. The diffusion plate 130 has a plate shape and is a predetermined thickness. The diffusion plate 130 is spaced apart from the flat fluorescent lamp 200 by a constant distance.

The diffusion plate 130 includes a transparent material and a diffusing agent. Examples of the transparent material that can be used for the diffusion plate 130 include a polymethyl methacrylate (PMMA), and polycarbonate (PC).

The optical sheets 140 modulate the light that has passed through the diffusion plate 130 to improve optical characteristics of the light. The optical sheets 140 may include a prism sheet that increases a luminance of the light when viewed on a plane.

In addition, the optical sheets 140 may further include a diffusion sheet to diffuse the light that has passed through the diffusion plate 130 to increase the luminance uniformity.

Furthermore, the optical sheets 140 may further include a reflective-polarizing sheet that transmits a portion of the light and reflects a remaining portion of the light, thereby increasing the light luminance. Alternatively, the optical sheets 140 may further include additional sheets or exclude one or more of the aforementioned sheets.

The backlight assembly 100 may further include a cushioning member 150 between the flat fluorescent lamp 200 and the receiving container 110 to support a peripheral portion of the flat fluorescent lamp 200.

The cushioning member 150 corresponds to the peripheral portion of the flat fluorescent lamp 200 so that the flat fluorescent lamp 200 is spaced apart from the receiving container 110 by a constant distance, thereby electrically insulating the flat fluorescent lamp 200 from the receiving container 110 having the metal.

The cushioning member 150 includes a material to absorb an externally provided impact, such as, for example, an elastic material. Referring to FIGS. 1 and 2, the cushioning member 150, for example, includes silicone that is an insulating and elastic material.

The cushioning member 150 corresponds to the electrode region EA of the flat fluorescent lamp 200. The cushioning member 150 may include two I shaped pieces. Alternatively, the cushioning member 150 may include two U shaped pieces. The cushioning member 150 may also include four pieces that correspond to four corners or four sides of the flat fluorescent lamp 200. The cushioning member 150 may be integrally formed to have a frame shape.

The backlight assembly 100 may further include a first mold 160 between the flat fluorescent lamp 200 and the diffusion plate 130.

The first mold 160 fixes sides of the flat fluorescent lamp 200 to the receiving container 110, and supports a peripheral portion of the diffusion plate 130. The first mold 160 blocks the electrode region EA of the flat fluorescent lamp 200 to prevent a shadow in the electrode region EA.

In FIGS. 1 and 2, the first mold 160 is integrally formed to have a frame shape. Alternatively, the first mold 160 may have two pieces having a U shape or an L shape. In another alternative, the first mold 160 may have four pieces corresponding to the four sides of the flat fluorescent lamp 200.

The backlight assembly 100 may further include a second mold 170 on the first mold 160 to fix the peripheral portion of the diffusion plate 130 and the optical sheets 140 to the first mold 160.

As shown in FIGS. 1 and 2, the second mold 170 is integrally formed to have a frame shape. Alternatively, the second mold 170 may include two pieces having a U shape or an L shape. In another alternative, the second mold 170 may have four pieces corresponding to the four sides of the flat fluorescent lamp 200.

The backlight assembly 100 may further include a heat releasing pad 180 corresponding to the electrode region EA of the flat fluorescent lamp 200. When an amount of the heat generated from the electrode region EA is greater than an amount of the heat generated from the effective light emitting area CA, the heat releasing pad 180 releases the heat of the electrode region EA so that the heat generated from the flat fluorescent lamp 200 is uniformly distributed.

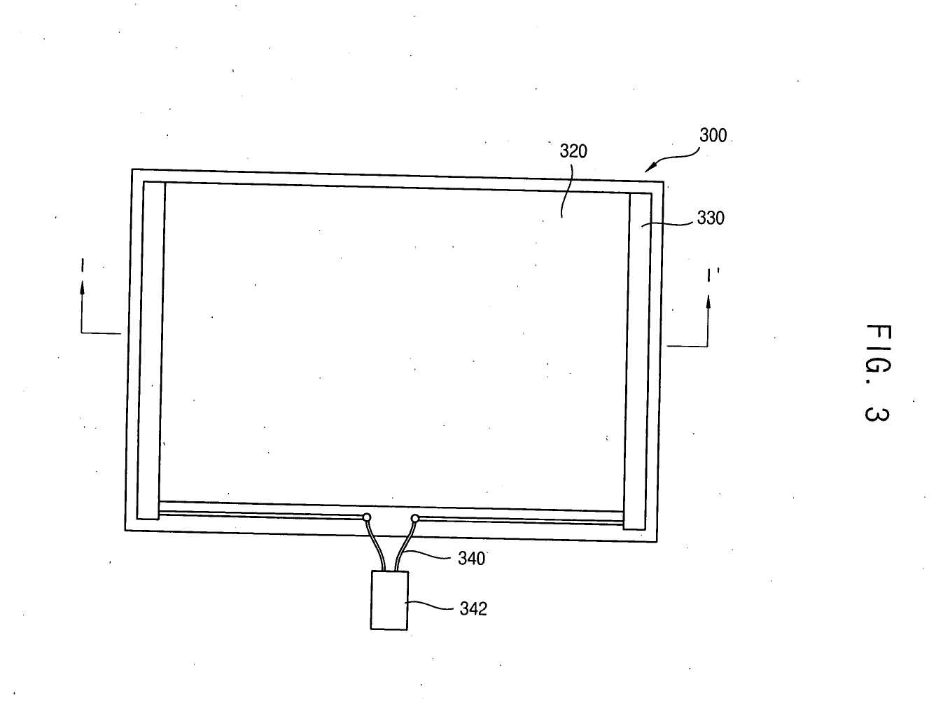

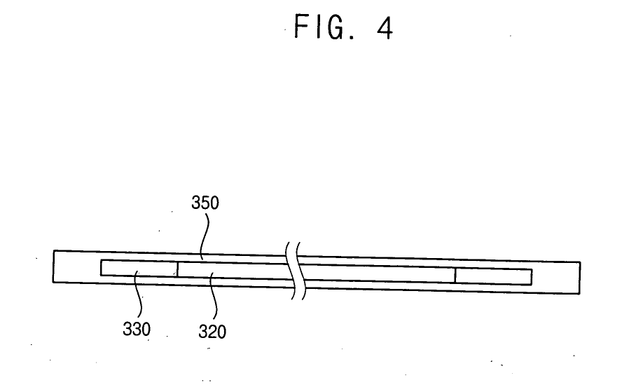

FIG. 3 is a plan view of a heat generating sheet shown in FIG. 1. FIG. 4 is a cross-sectional view taken along a line I-I′ shown in FIG. 3.

Referring to FIGS. 3 and 4, the heat generating sheet 300 includes a heat generating plate 320, electrode portions 330 and power supply lines 340. The electrode portions 330 are positioned on two end portions of the heat generating plate 320. The power supply lines 340 are electrically connected to the electrode portions 330.

The heat generating plate 320 has a thin film shape corresponding to the effective light emitting region CA of the flat fluorescent lamp 200. In an embodiment, the heat generating plate 320 includes a carbon that has high electric resistance. When the electric power is applied to the electrode portions 330, heat is generated from the heat generating plate 320.

The electrode portions 330 may be on opposite end portions of the heat generating plate 320, respectively. In an embodiment, the electrode portions 330 include copper, and have an extended plate shape. Alternatively, each of the electrode portions 330 may have an L shape, or various other shapes.

Electric power is applied to the heat generating sheet 300 through the power supply lines 340. An end portion of each of the electrode portions 330 is electrically connected to the power supply line 340. A connector 342 is electrically connected between the power supply lines 340 and the power supplying part 120 (shown in FIG. 1).

Referring to FIG. 3, the heat generating sheet 300 may further include an insulating layer 350. The insulating layer 350 is on an exposed surface of the electrode portions 330 and the heat generating plate 320 to protect the heat generating plate 320 and the electrode portions 330. The insulating layer 350 also electrically insulates the heat generating plate 320 and the electrode portions 330 from other elements such as the receiving container 110 (shown in FIG. 1). For example, the insulating layer 350 includes an epoxy resin.

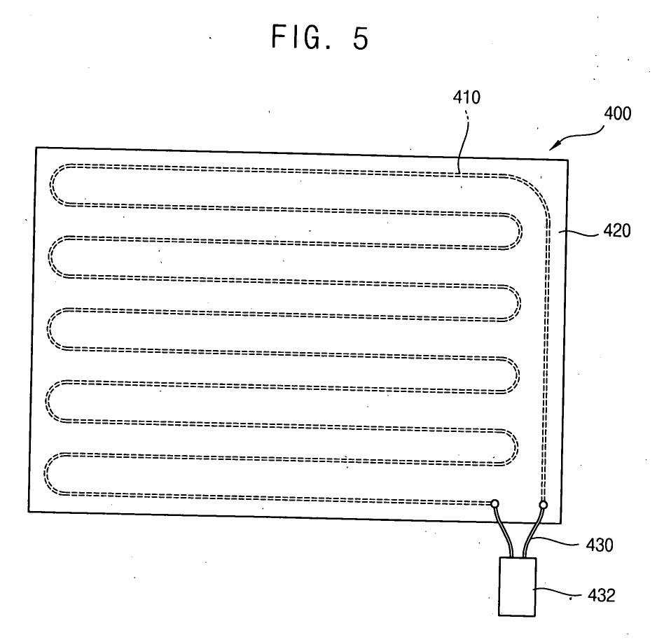

FIG. 5 is a plan view showing a heat generating sheet in accordance with another embodiment of the present invention.

Referring to FIG. 5, the heat generating sheet 400 includes a heating line 410, an insulating layer 420 and power supply lines 430. The insulating layer 420 is positioned on the heating line 410. Electric power is applied to the heating line 410 through the power supply lines 430.

The heating line 410 is uniformly distributed in an effective light emitting region CA of a flat fluorescent lamp 200. For example, the heating line 410 is a metal wire.

The heating line 410 generates heat based on the electric power that is provided from an exterior to the heat generating sheet 400. The heating line 410 may correspond to discharge spaces of the flat fluorescent lamp 200.

The insulating layer 420 is on an upper surface and a lower surface of the heating line 410. For example, the insulating layer 420 includes an epoxy resin.

The electric power is applied to the heating line 410 through the power supply lines 430 so that the heat generating sheet 400 generates the heat. The power supply lines 430 are electrically connected between the heating line 410 and a connecter 432 that is electrically connected to a power supplying part.

Alternatively, the heat generating sheet may have various heat sources such as, for example, an infrared based heat source, and a visible light based heat source.

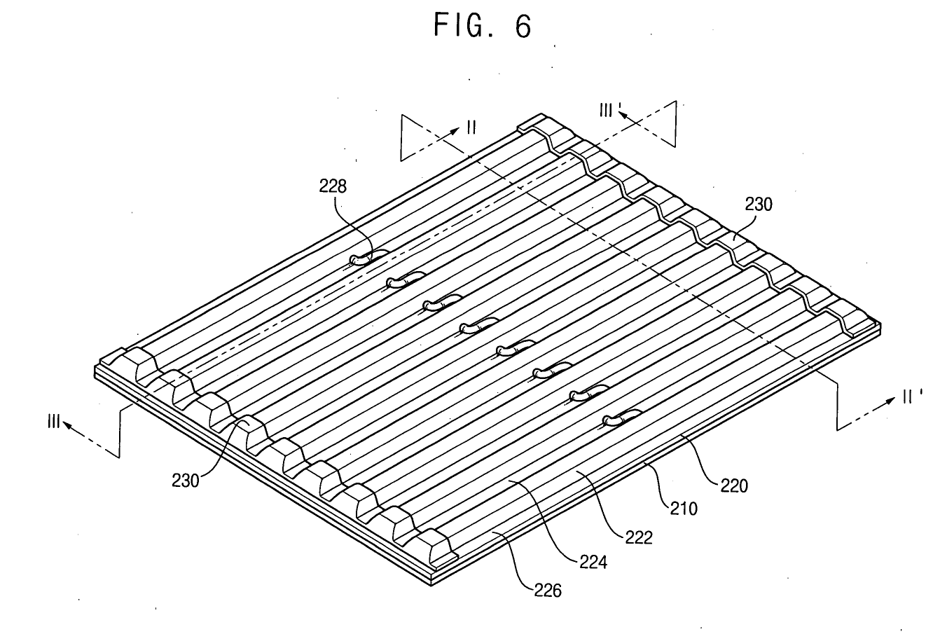

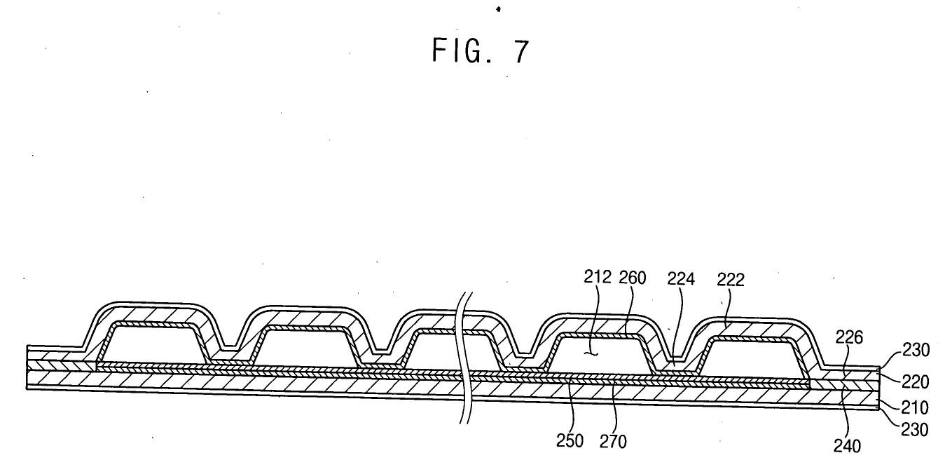

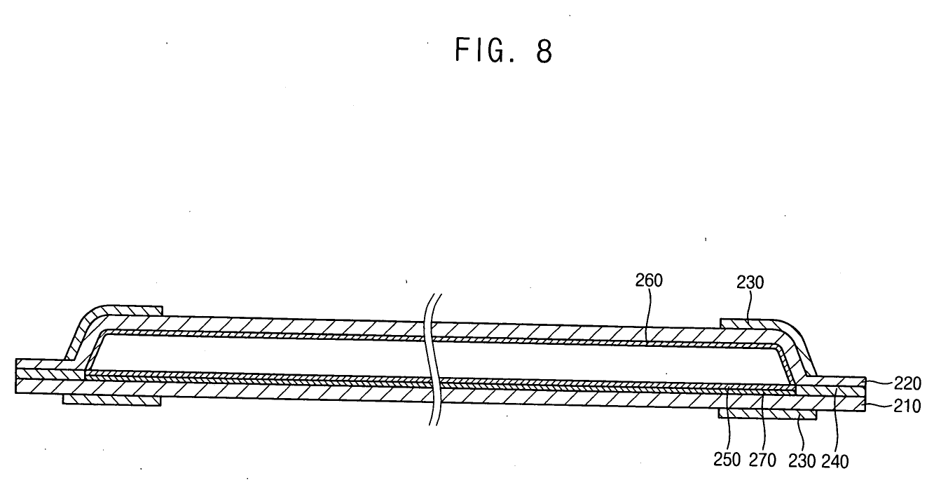

FIG. 6 is a perspective view of a flat fluorescent lamp shown in FIG. 1. FIG. 7 is a cross-sectional view taken along a line II-II′ shown in FIG. 6. FIG. 8 is a cross-sectional view taken along a line III-III′ shown in FIG. 6.

Referring to FIGS. 6 to 8, the flat fluorescent lamp 200 includes a lower substrate 210, an upper substrate 220 and an external electrode 230. The upper substrate 220 is combined with the lower substrate 210 to form a plurality of discharge spaces 212. The electric power is applied to the discharge spaces 212 through the external electrode 230.

The lower substrate 210 has a substantially quadrangular plate shape. For example, the lower substrate 210 may include a glass substrate.

The upper substrate 220 is molded to have a shape corresponding to the discharge spaces 212. The upper substrate 220 includes a transparent material. Examples of the transparent material that can be used for the upper substrate 220 include glass, and quartz.

The upper substrate 220 is formed through a molding process. In an embodiment, a glass plate is heated and pressed to form the upper substrate 220 having the shape corresponding to the discharge spaces 212. Alternatively, the upper substrate 220 may be formed through a blow molding process. In the blow molding process, the glass plate is heated and compressed by air to form the upper substrate 220.

The upper substrate 220 includes a plurality of discharge space portions 222, a plurality of space dividing portions 224 and a sealing portion 226. The discharge space portions 222 are spaced apart from the lower substrate 210 to form the discharge spaces 212. The space dividing portions 224 are between the discharge space portions 222, and make contact with the lower substrate 210 to define sides of the discharge spaces 212. As shown in FIGS. 6 and 7, the sealing portion 226 is adjacent to sides of the upper substrate 220 so that the lower substrate 210 is combined with the upper substrate 220. That is, the sealing portion 226 is located at edges of the flat fluorescent lamp 200.

A cross-section of the upper substrate 220 includes a plurality of trapezoidal shapes that are connected to each other. The trapezoidal shapes have rounded corners, and are arranged to be substantially parallel to each other. Alternatively, the cross-section of the upper substrate 220 may include a plurality of semicircular shapes, quadrangular shapes, or polygonal shapes.

A connecting passage 228 is formed on the upper substrate 220 to connect the discharge spaces 212 adjacent to each other. In an exemplary embodiment, at least one connecting passage 228 is formed on each of the space dividing portions 224. Each of the connecting passages 228 is spaced apart from the lower substrate 210 by a predetermined distance.

The connecting passages 228 may be formed through the molding process for forming the upper substrate 220. The discharge gas that is injected into one of the discharge spaces 212 may pass through each of the connecting passages 228 so that pressure in the discharge spaces 212 is substantially equal to one another. Each of the connecting passages 228 has various shapes such as, for example, an ‘S’ shape, or a linear shape. When each of the connecting passages 228 has the ‘S’ shape, a path length between the adjacent discharge spaces 212 is increased so that a current formed by the discharge voltage uniformly flows through the discharge spaces 212.

An adhesive 240 such as a frit is interposed between the lower and upper substrates 210 and 220 to combine the lower substrate 210 with the upper substrate 220. In an embodiment, the frit is a mixture of glass and metal, and a melting point of the frit is lower than that of pure glass.

The adhesive 240 is prepared on the sealing portion 226 between the lower and upper substrates 210 and 220, and the adhesive 240 is fired and solidified, thereby combining the lower substrate 210 to the upper substrate 220.

The lower substrate 210 is combined with the lower substrate 220, and air between the lower and upper substrates 210 and 220 is discharged so that the discharge spaces 212 are evacuated. A discharge gas is injected into the evacuated discharge spaces 212. For example, the discharge gas includes mercury, neon, or argon.

The space dividing portions 224 of the upper substrate 220 are combined with the lower substrate 210 by a pressure difference between the discharge spaces 212 and an outside of the flat fluorescent lamp 200. In an exemplary embodiment, a pressure of the discharge gas in the discharge spaces 212 is about 50 Torr to about 70 Torr, and an atmospheric pressure outside of the flat fluorescent lamp is about 760 Torr, thereby forming the pressure difference. As a result, the space dividing portions 224 are combined with the first substrate 210.

The external electrodes 230 are on at least one of a lower surface of the lower substrate 210 and an upper surface of the upper substrate 220. The external electrodes 230 are positioned on sides opposite to the discharge spaces 212. The external electrodes 230 cross the discharge spaces 212 so that the electric power may be applied to the discharge spaces 212.

When the external electrodes 230 are on the lower surface of the lower substrate 210 and the upper surface of the upper substrate 220, the external electrodes 230 on each of the sides of the flat fluorescent lamp 200 may be electrically connected to each other through a conductive clip (not shown).

The external electrodes 230 include a conductive material. A silver paste that is a mixture of silver (Ag) and silicon oxide (SiO2) may be coated on the lower and upper substrates 210 and 220 to form the external electrodes 230. Alternatively, metal powder may be coated on the lower and upper substrates 210 and 220 to form the external electrodes 230. The external electrodes 230 may be formed through, for example, a spray process, a spin coating process, or a dipping process. A metal socket may be combined with the lower and upper substrates 210 and 220 to form the external electrodes 230.

In an embodiment, the upper substrate may have the shape corresponding to the discharge spaces. A plurality of space dividing members may be interposed between the upper and lower substrates that have a substantially planar shape to form the discharge spaces.

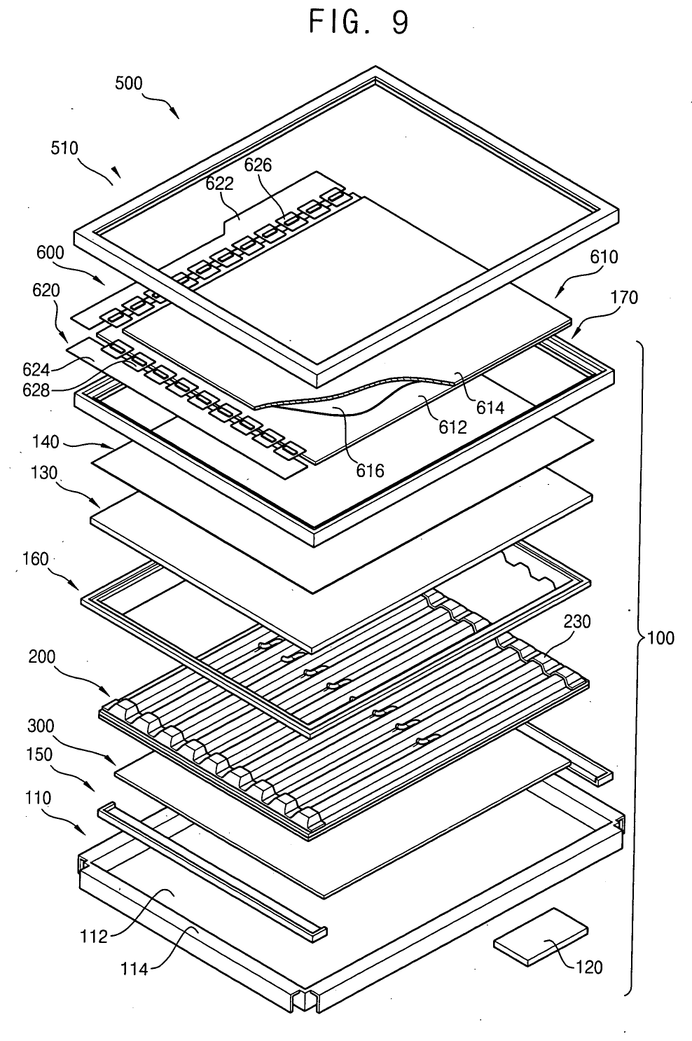

FIG. 9 is an exploded perspective view showing a liquid crystal display (LCD) device in accordance with an embodiment of the present invention.

Referring to FIG. 9, the LCD device 500 includes a backlight assembly 100 and a display unit 600. The backlight assembly 100 generates light. The display unit 600 displays an image.

The backlight assembly of FIG. 9 is same as in FIG. 1. Thus, the same reference numerals are used to refer to the same or like parts as those described in FIG. 1.

The display unit 600 includes an LCD panel 610 and a driving circuit part 620. The LCD panel 610 displays the image based on the light generated from the backlight assembly 100. The driving circuit part 620 generates control signals to drive the LCD panel 610.

The LCD panel 610 includes a first substrate 612, a second substrate 614 and a liquid crystal layer 616. The second substrate 614 corresponds to the first substrate 612. The liquid crystal layer 616 is interposed between the first and second substrates 612 and 614.

The first substrate 612 includes a plurality of thin film transistors (TFTs) that are arranged in a matrix shape. A source electrode (not shown), a gate electrode (not shown) and a drain electrode (not shown) of each of the TFTs are electrically connected to a data line (not shown), a gate line (not shown) and a pixel electrode (not shown), respectively. The pixel electrode includes a transparent conductive material.

The second substrate 614 is a color filter substrate that includes a red pixel (not shown), a green pixel (not shown) and a blue pixel (not shown) to display a red light, a green light and a blue light, respectively. The second substrate 614 further includes a common electrode (not shown) that has a transparent conductive material.

When a driving voltage is applied to the gate electrode of each of the TFTs so that the TFT is turned on, an electric field is formed between the pixel electrode and the common electrode. Therefore, an arrangement of the liquid crystal layer 616 between the first and second substrates 612 and 614 is changed by the electric field applied to the liquid crystal layer 616 so that a light transmittance of the liquid crystal layer 616 is changed to display the image having a predetermined gray-scale.

The driving circuit part 620 includes a data printed circuit board (PCB) 622, a gate PCB 624, a data driving circuit film 626 and a gate driving circuit film 628. The data PCB 622 applies a data driving signal to the LCD panel 610. The gate PCB 624 applies a gate driving signal to the LCD panel 610. The data PCB 622 is electrically connected to the LCD panel 610 through a data driving circuit film 626. The gate PCB 624 is electrically connected to the LCD panel 610 through a gate driving circuit film 628.

Each of the data driving circuit films 626 and the gate driving circuit films 628 includes a tape carrier package (TCP) or a chip on film (COF). Alternatively, an additional line is formed on the LCD panel 610 and the gate driving circuit film 628 so that the gate PCB 624 may be omitted.

The LCD device 500 may further include a top chassis 510 to fix the display unit 600 to the backlight assembly 100. The top chassis 510 is combined with the receiving container 110 to fix a peripheral portion of the LCD panel 610 to the backlight assembly 100. The data driving circuit film 626 is bent toward a rear surface of the receiving container 110 so that the data PCB 622 can be positioned on a side surface or the rear surface of the receiving container 110. The top chassis 510 may include a metal that is strong enough to avoid being deformed.

According to embodiments of the present invention, the heat generating sheet is positioned adjacent to the flat fluorescent lamp, for example, under or to the rear of the flat fluorescent lamp, to supply the effective light emitting region of the flat fluorescent lamp with heat. Therefore, the time for stabilizing the flat fluorescent lamp is decreased, and the light emitting characteristics of the flat fluorescent lamp are improved.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A backlight assembly comprising:
a receiving container;
a flat fluorescent lamp received in the receiving container, the flat fluorescent lamp including a plurality of discharge spaces to generate light; and
a heat generating sheet positioned adjacent to the flat fluorescent lamp to supply the flat fluorescent lamp with heat.

2. The backlight assembly of claim 1, wherein the position of the heat generating sheet corresponds to an effective light emitting region of the flat fluorescent lamp.

3. The backlight assembly of claim 1, wherein the heat generating sheet is fixed to a bottom surface of the receiving container through an adhesive member.

4. The backlight assembly of claim 1, wherein the heat generating sheet comprises:
a heat generating plate;
electrode portions positioned on end portions of the heat generating plate; and
a power supply line electrically connected to the electrode portions to apply electric power to the electrode portions.

5. The backlight assembly of claim 4, wherein the heat generating sheet further includes an insulating layer formed on a surface of the electrode portions and the heat generating plate.

6. The backlight assembly of claim 4, wherein the heat generating plate comprises carbon.

7. The backlight assembly of claim 1, wherein the heat generating sheet comprises:
a heating line including a metal wire;
an insulating layer formed on the heating line; and
a power supply line through which electric power is applied to the heating line.

8. The backlight assembly of claim 1, wherein the flat fluorescent lamp comprises:
a lower substrate;
an upper substrate combined with the lower substrate to form the discharge spaces; and
an external electrode on at least one of a lower surface of the lower substrate or an upper surface of the upper substrate, the external electrode crossing the discharge spaces.

9. The backlight assembly of claim 8, wherein the upper substrate comprises:
a plurality of discharge space portions spaced apart from the lower substrate to form the discharge spaces;
a plurality of space dividing portions positioned between the discharge space portions, the space dividing portions making contact with the lower substrate; and
a sealing portion positioned on a peripheral portion of the upper substrate.

10. The backlight assembly of claim 1, further comprising a power supplying part that applies electric power to the flat fluorescent lamp and to the heat generating sheet.

11. The backlight assembly of claim 10, further comprising:
a diffusion plate positioned on the flat fluorescent lamp to diffuse the light generated from the flat fluorescent lamp; and
optical sheets positioned on the diffusion sheet.

12. The backlight assembly of claim 11, further comprising:
a cushioning member positioned between the flat fluorescent lamp and the receiving container to support a peripheral portion of the flat fluorescent lamp;
a first mold covering an electrode region of the flat fluorescent lamp to fix the peripheral portion of the flat fluorescent lamp to the receiving container; and
a second mold positioned on the first mold, to fix a peripheral portion of the optical sheets to the first mold.

13. The backlight assembly of claim 1, wherein the heat generating sheet is positioned under the flat fluorescent lamp.

14. A liquid crystal display device comprising:
a backlight assembly for generating light, the backlight assembly including:
a receiving container;
a flat fluorescent lamp received in the receiving container, the flat fluorescent lamp including a plurality of discharge spaces to generate the light; and
a heat generating sheet positioned adjacent to the flat fluorescent lamp to supply the flat fluorescent lamp with heat; and
a display unit including a liquid crystal display panel that displays an image using the light generated from the backlight assembly, and a driving circuit part that generates control signals to drive the liquid crystal display panel.

15. The liquid crystal display device of claim 14, wherein the heat generating sheet is on a bottom surface of the receiving container corresponding to an effective light emitting region of the flat fluorescent lamp.

16. The liquid crystal display device of claim 14, wherein the heat generating sheet comprises:
a heat generating plate;
electrode portions positioned on end portions of the heat generating plate;
an insulating layer formed on a surface of the heat generating plate and the electrode portions; and
a power supply line electrically connected to the electrode portions to apply electric power to the electrode portions.

17. The liquid crystal display device of claim 14, wherein the heat generating sheet comprises:
a heating line including a metal wire;
an insulating layer formed on the heating line; and
a power supply line through which electric power is applied to the heating line.

18. The liquid crystal display device of claim 14, wherein the backlight assembly comprises:
a power supplying part that applies electric power to the flat fluorescent lamp and to the heat generating sheet;
a diffusion plate positioned on the flat fluorescent lamp to diffuse the light generated from the flat fluorescent lamp; and
optical sheets positioned on the diffusion plate.

19. The liquid crystal display device of claim 14, wherein the heat generating sheet is positioned under the flat fluorescent lamp.
